(19) United States
(12) Patent Application Publication
(10) Pub. No.: US 2018/0274518 A1
(43) Pub. Date: Sep. 27, 2018

(54) WIND TURBINE ROTOR BLADE AND WIND TURBINE SYSTEM

(71) Applicant: Wobben Properties GmbH, Aurich (DE)

(72) Inventors: Falk SPIETH, Aurich (DE); Alexander HOFFMANN, Emden (DE); Rasmus BÖRCHERS, Aurich (DE)

(21) Appl. No.: 15/764,777

(22) PCT Filed: Sep. 26, 2016
(86) PCT No.: PCT/EP2016/072793

§ 371 Date: Mar. 29, 2018

(30) Foreign Application Priority Data
Oct. 1, 2015 (DE) 10 2015 116 634.8

(51) Int. Cl. F03D 1/06

(52) U.S. Cl. CPC F03D 1/0683; F05B 2260/301; F05B 2240/301; F03D 1/0641

(57) ABSTRACT

A rotor blade of a wind turbine. The wind turbine rotor blade includes a blade root for connection of the rotor blade to a rotor hub, an inner blade portion which extends from the blade root in the direction of the longitudinal axis of the rotor blade, at least one trailing edge segment portion of a trailing edge segment for increasing the profile depth of the rotor blade at the blade root and at least one first and second securing portions for securing the at least one trailing edge segment portion of the trailing edge segment to the inner blade portion. The first securing portion is arranged at a predetermined spacing from the second securing portion in the direction of the longitudinal axis of the rotor blade and the at least one trailing edge segment portion of the trailing edge segment is secured to the inner blade portion in such a way that loads occurring at the inner blade portion are transmitted in point form to the at least one trailing edge segment portion of the trailing edge segment by way of the first and second securing portions.

### BACKGROUND

### Technical Field

The invention concerns a wind turbine rotor blade having at least one trailing edge segment portion and an inner blade portion of a wind turbine, a wind turbine and a method of connecting a trailing edge segment portion to an inner blade portion of a rotor blade.

### Description of the Related Art

The design of rotor blades is essential for the efficiency of a wind turbine. A possible way of increasing the efficiency and power output of the wind turbine by way of the design of the rotor blade is to design the configuration of the rotor blade in the region of the rotor blade root with a larger profile depth, that is to say to make the length of the rotor blade between the rotor blade trailing edge and the rotor blade nose as large as possible. In that respect, the region of the rotor blade root is used to denote the region of the rotor blade, at which the rotor blade is secured to the hub. In the case of such a rotor blade the maximum profile depth is very close to the end region of the rotor blade at the rotor blade root. In that way turbulence generation is reduced and thus the efficiency of the overall wind turbine is increased.

Particularly in the case of larger wind turbines involving rotor diameters of greater than 60 meters such an increase in the profile depth of the rotor blade at the rotor blade root can lead to problems in transport as the maximum profile depth in the case of such rotor blades is five meters or more. When transporting such rotor blades on land a high level of logistical involvement is required in order to transport the rotor blade through tight curves or under bridges. Detours have to be accepted or the corresponding road layouts have to be adapted and for example road signs or the like have to be removed. As an alternative thereto it is possible to use expensive vehicle technology with vehicle hoists.

To resolve that problem it is already known for the rotor blade to be provided with a separate trailing edge segment in the region of the rotor blade root in order to achieve a maximum profile depth at that location. In that way it is possible for the trailing edge segment or a part or portion thereof to be fitted only at the wind turbine erection site. In the case of such structures the trailing edge segment or a trailing edge segment portion has hitherto been secured over its entire length in the longitudinal direction of the blade to the inner blade portion. In that way the loadings occurring at the inner blade of the rotor blade are transmitted to the trailing edge segment. The inner blade of a rotor blade is the load-bearing structure at which an aerodynamic cladding which forms the aerodynamic profile of the rotor blade is secured at a later time during manufacture of the rotor blade. In that case the loads occurring at the inner blade are particularly high in particular in the connecting region to the hub due to the concentration there of the rotor forces in the event of extremely high alternating stresses. As a result the connecting region between the rotor blade or the inner blade and the trailing edge segment or the trailing edge segment portion is also subjected to very high loadings. As a result that can lead to damage in the connecting region or at the trailing edge segment and/or the rotor blade. The design configuration of the connecting region is therefore hitherto complicated and costly. In addition the amount of connecting materials required like adhesive or other connecting elements is very high, resulting in high cost levels.

On the German patent application from which priority is claimed the German Patent and Trade Mark Office cited the following documents as state of the art: DE 20 2011 103 091 U1, DE 10 2013 101 232 A1, DE 10 2011 088 025 A1, DE 10 2006 022 279 A1 and WO 2011/088835 A2.

### BRIEF SUMMARY

Provided is a solution by which the loading on the trailing edge segment is reduced, with at the same time a cost reduction and a simple design. At least the invention seeks to propose an alternative solution.

A wind turbine rotor blade includes a blade root for connection of the rotor blade to a rotor hub, an inner blade portion which extends from the blade root in the direction of the longitudinal axis of the rotor blade, at least one trailing edge segment portion of a trailing edge segment for increasing the profile depth of the rotor blade at the blade root and at least one first and second securing portions for fixing the at least one trailing edge segment portion of the trailing edge segment to the inner blade portion. The first securing portion is arranged at a predetermined spacing from the second securing portion in the direction of the longitudinal axis of the rotor blade and the at least one trailing edge segment portion of the trailing edge segment is secured to the inner blade portion in such a way that loads occurring at the inner blade portion are transmitted in point form to the at least one trailing edge segment portion of the trailing edge segment by way of the first and second securing portions. As the trailing edge segment portions are only secured in point form to the inner blade portion that entails load decoupling between the inner blade portion and the trailing edge segment.

The rear box structure and an outer blade can be secured to the inner blade portion.

In that connection the inner blade portion is the region of the inner blade which joins the blade root. The inner blade can optionally extend to the blade tip of the rotor blade. The inner blade portion is then at least the portion of the inner blade, at which the at least one trailing edge segment portion of the trailing edge segment is arranged, that is to say the portion of the inner blade which substantially corresponds to the length of the trailing edge segment.

The term the at least one trailing edge segment portion is used to denote at least a part of the trailing edge segment. The trailing edge segment can be made up from a single or a plurality of trailing edge segment portions. In that respect a plurality of trailing edge segment portions have the advantage that for example a trailing edge segment portion is already secured to the inner blade portion of the rotor blade in the manufacturing facility. It is possible in that way to better observe tolerances. To increase the profile depth further trailing edge segment portions can then be fitted to the already assembled trailing edge segment portion, at the wind turbine erection site, in order in that way to reduce the logistical complications when transporting the rotor blade to the erection site.

At least one first and second securing portions arranged at a predetermined spacing relative to each other are provided for securing the at least one trailing edge segment portion to the inner blade portion. In that case the first securing portion is arranged for example in the (immediate) proximity with the blade root and the second securing portion is arranged in the immediate proximity with the end, opposite to the blade root, of the trailing edge segment portion, or vice-versa. Such a spacing of the two securing portions ensures a concentrated application of force of the forces occurring at the inner blade portion to the trailing edge segment portion with at the same time adequate securing and a saving on connecting materials. In that way the overall loads occurring at the rotor blade are no longer transmitted to the trailing edge segment portion, but only a part thereof. Loadings in the connecting region or at the trailing edge segment are thereby considerably reduced. Costs for materials in the connecting region are also reduced. The trailing edge segment in accordance with the invention is decoupled from the flexing of the rotor blade (that is to the inner blade). Therefore fewer loads occur in the trailing edge segment. In accordance with the invention the trailing edge segment portions are no longer adhesively secured over the entire surface area to the inner blade, but are only connected to the inner blade in point form (for example twice). That results in a considerably improved load decoupling effect between the inner blade and the trailing edge segment.

Alternatively it is possible to provide for an application of load by way of a plurality of securing portions. In particular a third, fourth, fifth and/or sixth securing portion is provided for that purpose, wherein each securing portion is at a predetermined spacing in the direction of the longitudinal axis of the rotor blade relative to the respectively next securing portion. According to an aspect of the invention the trailing edge segment has for example two bulkheads.

In a preferred embodiment the trailing edge segment portions each have a top side (pressure side) and an underside (suction side) which form a receiving space and the first and second securing portions are disposed in the receiving space. In that way the first and the second securing portions are surrounded by the top side and the underside of the trailing edge segment portion and are thus protected from environmental influences. That avoids damage to the securing portions due to weather influences or the like. The aerodynamics of the rotor blade is also not adversely affected.

Preferably the at least one trailing edge segment portion has in the first and second securing portions a first and a second reinforcing rib for reinforcing the at least one trailing edge segment portion, and the first and second reinforcing ribs are adapted for connection to the inner blade portion. Alternatively or in addition thereto a first and a second connecting rib is arranged at the inner blade portion in the first and second securing portions, and the first and second connecting ribs are adapted for connection to the at least one trailing edge segment portion. Accordingly the first and the second reinforcing rib is arranged in particular between the top side and underside, that is to say in the receiving space of the trailing edge segment portion, and is connected to the top side and the underside by way of an adhesive join. The connection to the inner blade portion can be effected by way of a connection of the first and second reinforcing ribs to the first and second connecting ribs respectively and/or by adaptation of the geometry of the connecting location between the respective connecting rib and the inner blade portion. In the case of a round inner portion the connecting rib accordingly has at the connecting location at least partially a recess having a quarter circle or a quarter circle segment for receiving the approximately round or elliptical inner blade portion.

In a preferred embodiment the first and the second reinforcing ribs respectively have a (longitudinal) edge which extends for example over the entire profile depth of the trailing edge segment portion and/or is secured within the receiving space to the top side and/or the underside of the trailing edge segment portion. The length of the respective reinforcing rib along the profile depth ensures on the one hand reinforcement of the trailing edge segment portion and on the other hand uniform load transmission. Securing of that edge in the interior of the trailing edge segment portion protects the connection from external influences.

In a particularly preferred embodiment the first and the second reinforcing ribs have a transverse edge adapted to the geometry of the inner blade portion. The transverse edge in that case extends from the top side to the underside of the trailing edge segment portion. Adaptation of the transverse edge to the geometry of the inner blade portion ensures accurately fitting connection between the trailing edge segment portion and the inner blade portion. The transverse edge can thus further fix the connection of the inner blade portion and the trailing edge segment portion. A fixed connection of the transverse edge or an adhesive foot portion to the inner blade portion is thereby also possible.

Preferably the first reinforcing rib and the first connecting rib as well as the second reinforcing rib and the second connecting rib are secured by way of a material-bonded and/or positively locking connection. In that case the reinforcing ribs and the connecting ribs are respectively connected together at a common contact surface. In that respect the respective connection method is adapted in dependence on the loads occurring and the geometrical structure of the trailing edge segment portion and the inner blade portion. A particularly firm connection is achieved by a combination of a positively locking and a material-bonded connection.

In a preferred embodiment the material-bonded connection includes an adhesive connection, in particular an adhesive connection involving a two-component adhesive. In that respect such an adhesive connection has the advantage that force transmission can be implemented when involving different materials, for example transmission of force from a glass fiber-reinforced plastic to an aluminum component. The cross-sections of the connecting ribs and the reinforcing ribs are not reduced and the distribution of force is uniform. In addition, fitment inaccuracies which can occur in manufacture can be compensated by an adhesive connection.

In a particularly preferred embodiment the positively locking connection includes a rivet connection, a screw connection, a bolt connection and/or a strap connection. When a high loading at the connecting locations is involved such connecting processes are advantageous. A rivet, screw and bolt connection has the advantage that they can transmit high loads and the required connecting elements can be produced with a high level of quality. That achieves a high degree of security in the region of the connection. In addition such a connecting procedure is inexpensive. In that respect, when a high application of load in point form is involved in particular a strap connection by dividing the load into two lines is advantageous.

Preferably the first reinforcing rib and the first connecting rib as well as the second reinforcing rib and the second connecting rib are arranged in mutually plane-parallel relationship. The plane-parallel relationship provides a sufficiently large surface area, by way of which the respective reinforcing ribs and connecting ribs form the connection. In addition that ensures contact which is as precise as possible at the contact surfaces of the respective reinforcing rib and connecting rib.

In a preferred embodiment the first and the second connecting ribs are of a U-shaped and/or I-shaped configuration. The U-shape is suitable in particular for a positively locking connection as material can be saved by virtue of the opening in the center. The double T-shape is suitable in that respect in particular for a material-bonded connection as the double T-shape provides a sufficiently large surface area for applying the adhesive.

In a particularly preferred embodiment drill holes are provided in the first and second connecting ribs for connecting the connecting rib to a reinforcing rib. In particular in that case two drill holes are provided to achieve a uniform application of force.

Preferably the inner blade portion is made from a fiber composite material, in particular a glass fiber-reinforced plastic. In that way the inner blade portion can be inexpensively produced specifically for the loads which occur.

In a preferred embodiment the inner blade portion is of an annular cross-section or an elliptical cross-section (concave flanges) and/or is in the form of a wound body. In that case such an inner blade portion is produced in particular from a glass fiber-reinforced plastic. In particular a glass fiber-reinforced mat impregnated with a resin-hardener mixture is wound or deposited on a winding core, in particular by an automated procedure, so that a so-called wound body is formed. When a circular winding core is used the winding body is accordingly of an annular cross-section. That ensures a uniform high level of quality with a manufacturing process for the inner blade portion, which at the same time is inexpensive.

In a particularly preferred embodiment the first and second connecting ribs are wound into the inner blade portion. That avoids additional assembly of the respective connecting ribs to the inner blade portion, whereby costs and possibly the overall weight of the rotor blade are reduced. In addition this ensures secure bonding of the respective connecting ribs to the inner blade portion.

In addition, there is proposed a wind turbine. In that respect the wind turbine includes a tower, a pod mounted rotatably to the tower, a rotor mounted rotatably to the pod and at least one rotor blade according to an embodiment as described hereinbefore. That affords the above-mentioned advantages to the same degree.

In addition, there is proposed a method of connecting at least one trailing edge segment portion to the inner blade portion of a rotor blade of a wind turbine according to one of the above-described embodiments. At least one trailing edge segment portion is prepared and an inner blade portion is prepared. The at least one trailing edge segment portion is connected to the inner blade portion at at least a first and a second securing portion at a predetermined spacing relative to each other in the direction of the longitudinal axis. In that way loads occurring at the inner blade portion are transmitted to the at least one trailing edge segment portion in point form by way of the first and the second securing portions.

In that respect the above-mentioned advantages are enjoyed to the same degree.

Preferably the at least one trailing edge segment portion is connected to the inner blade portion in positively locking and/or material-bonded relationship, in particular by means of a rivet connection, a screw connection, a bolt connection, a strap connection or an adhesive connection. In that respect the respective connecting process is adapted in dependence on the loads which occur and the geometrical structure of the trailing edge segment portion and the inner blade portion. A particularly strong connection is achieved by a combination of a positively locking and material-bonded connection.

### BRIEF DESCRIPTION OF THE SEVERAL VIEWS OF THE DRAWINGS

The invention is described by way of example hereinafter by means of embodiments with reference to the accompanying Figures. The Figures involve in part simplified, diagrammatic views.

FIG. 1 shows a wind turbine according to the present invention,

FIG. 2 shows a portion of a rotor blade with a trailing edge segment according to the invention,

FIG. 3 shows a portion of a rotor blade with a trailing edge segment according to a first embodiment of the invention,

FIG. 4 shows a front view of a portion of a rotor blade with a trailing edge segment according to a second embodiment of the invention,

FIG. 5 shows a portion of a trailing edge segment according to the invention,

FIG. 6 shows a diagrammatic view of a portion of a rotor blade according to the invention, and

FIG. 7 shows a diagrammatic view of a trailing edge segment portion according to the invention.

### DETAILED DESCRIPTION

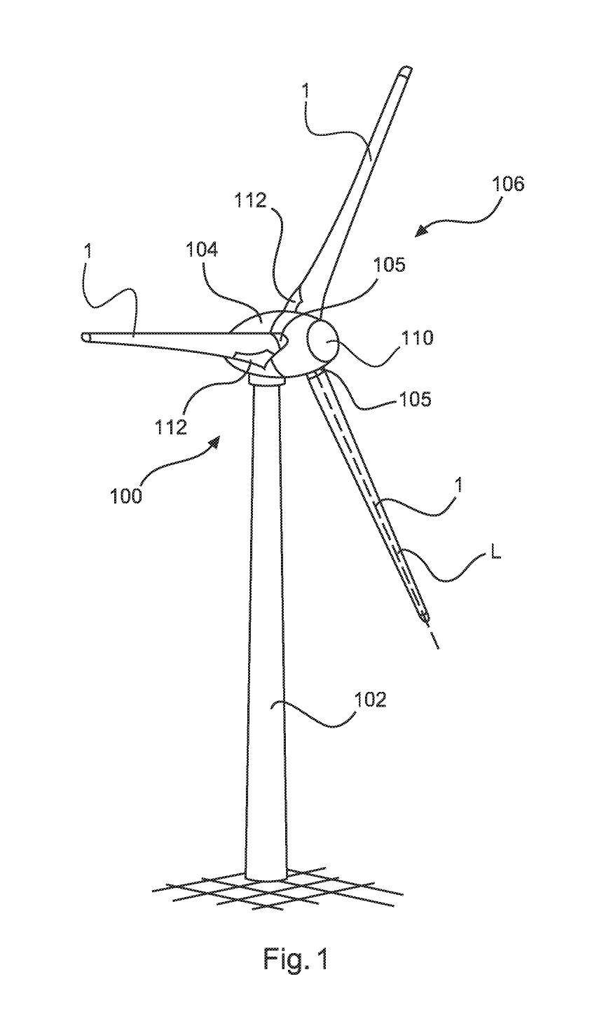

FIG. 1 shows a wind turbine 100 having a tower 102 and a pod 104. Arranged at the pod 104 is a rotor 106 having a spinner 110 and three rotor blades 1 each having a respective trailing edge segment 112. The rotor blades 1 are respectively secured to a hub 105. In operation of the turbine the rotor 106 is caused to rotate by the wind and thereby drives a generator (not shown) in the pod 104.

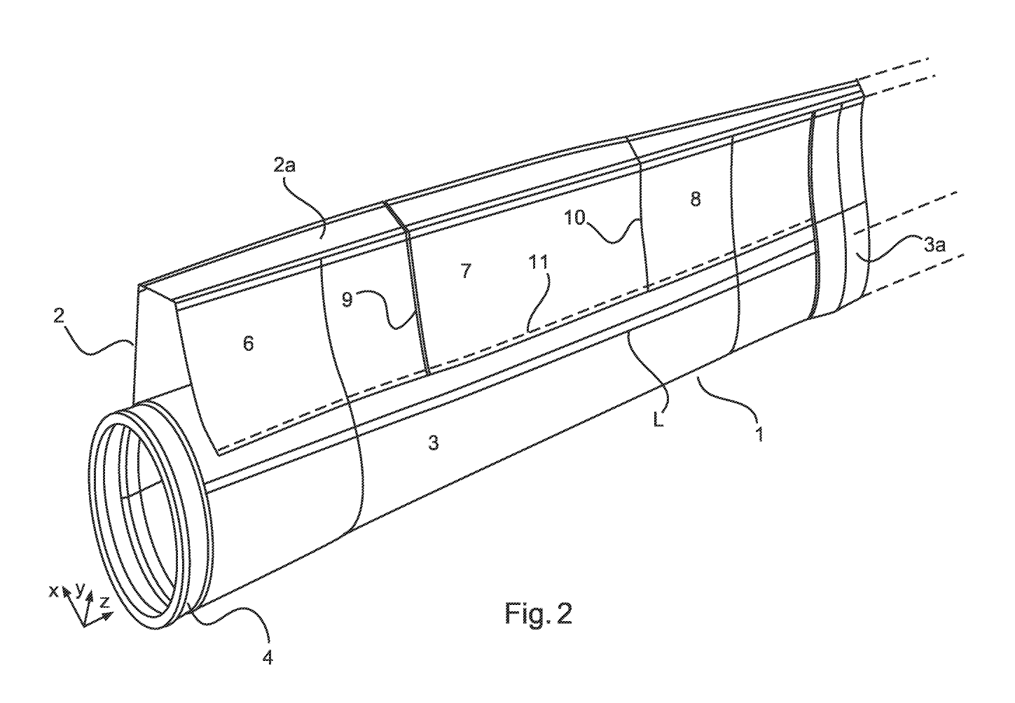

FIG. 2 shows a portion of a wind turbine rotor blade 1 having a longitudinal axis L, an inner blade portion 3, a trailing edge segment 2 and a blade root 4. The rotor blade 1 is of the largest profile depth in the region of the blade root 4. A blade separation location or a blade separation flange 3a is provided at an inner blade portion 3. A further blade portion can be provided at the blade separation location or flange and represent the aerodynamic profile of the rotor blade 1. The trailing edge segment 2 can optionally have a flattened end 2a.

The trailing edge segment 2 can optionally be subdivided into four individual segments 6, 7, 8 as embodiments by way of example of trailing edge segment portions. The individual segments 6, 7 and 8 are arranged in mutually adjacent relationship and are not connected together.

In that respect such a rotor blade 1 has the advantage that a part of the trailing edge segment 2 like the individual segment can already be secured to the inner blade portion 3 at the manufacturing facility while the further individual segments 6, 7 and 8 can be fitted only at the erection site. The logistical involvement in terms of transport is reduced in relation to a completely assembled rotor blade so that for example rail transport operations are possible.

As an alternative to the embodiment in FIG. 2 the trailing edge segment 2 can also be in one piece or can comprise two or more individual segments.

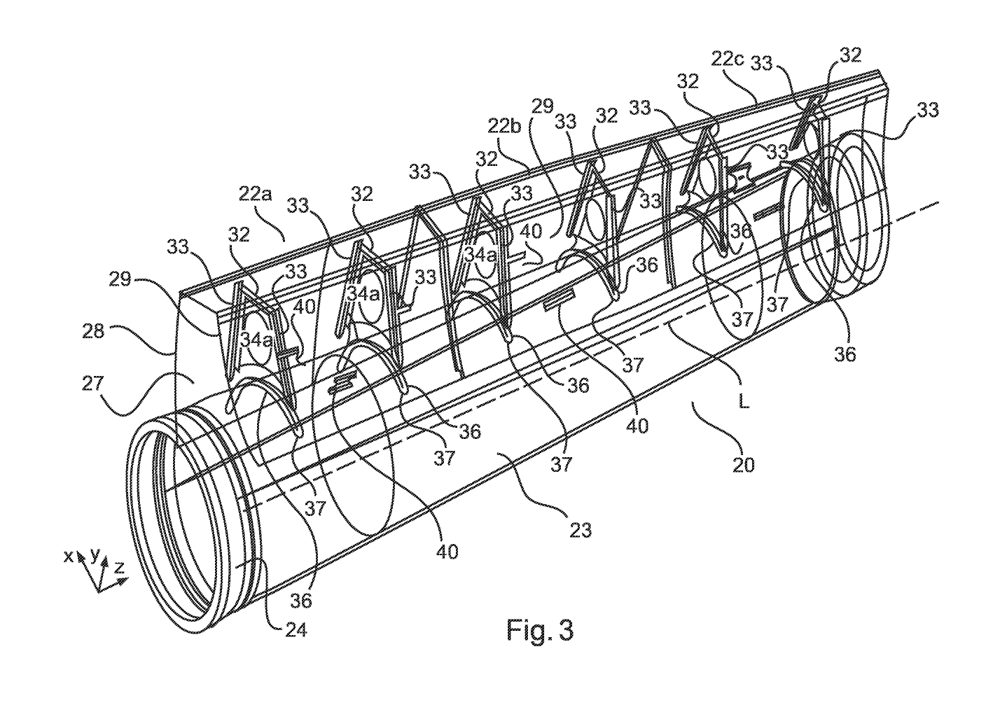

FIG. 3 shows a portion of a rotor blade 20 which has a part or a portion of a trailing edge segment 22 and an inner blade portion 23. The trailing edge segment 22 has a plurality of trailing edge segment portions 22a-22c. The inner blade portion 23 extends in this case from the rotor blade root 24 in the direction of the longitudinal axis L of the rotor blade 20. In FIG. 3 the inner blade portion 23 is of an annular or elliptical cross-section. When the inner blade portion 23 is made from a fiber composite material, in particular a glass fiber mat, such an annular or elliptical cross-section is preferably produced by means of a rotating core, around which glass fiber mat is wound in order to avoid fluctuations in quality in the inner blade portion and to shorten the production time. The inner blade portion 23 can represent a wound blade body.

The trailing edge segment portions 22a-22c have a top side (pressure side) 29 and an underside (suction side) 28 forming a receiving space 27. Six reinforcing ribs 32 are disposed in the receiving space 27. The reinforcing ribs 32 can be provided perpendicularly to the longitudinal axis L of the rotor blade 20 and arranged in mutually spaced relationship. The reinforcing ribs 32 are each secured with their longitudinal edges 33 by way of an adhesive from the inside to the top side 29 and the underside 28 respectively of the trailing edge segment portion 22 and are adapted to reinforce the trailing edge segment portion 22 and to connect it to the inner blade portion 23. The reinforcing ribs 32 are of such a configuration that they transmit scarcely any loadings from the inner blade portion 23 to the trailing edge segment portion 22. To save on material the reinforcing ribs 32 can each have two openings at the locations at which the material would otherwise not be completely utilized. Optionally the reinforcing ribs 32 can have an opening 34a.

At the transverse edge 36 that is towards the inner blade portion 23 the reinforcing ribs 32 are respectively adapted to be geometry of the inner blade portion 23. In FIG. 3 accordingly the transverse edges 36 are of a semicircular or elliptical configuration. Preferably the transverse edges 36 are secured to the inner blade portion 23 by means of an adhesive.

At the inner blade portion 23 six U-shaped connecting ribs 37 (not shown in FIG. 3) can be respectively arranged in corresponding relationship with the six reinforcing ribs 32. The connecting ribs 37 are each spaced in the direction of the longitudinal axis L and arranged in mutually parallel relationship. They are provided in plane-parallel relationship with the reinforcing ribs 32. When the inner blade portion 23 is in the form of a fiber composite component the connecting ribs 37 are also produced by winding in the winding process, that is to say the manufacturing process. There is therefore no additional working step for fitting the connecting ribs. Alternatively the connecting ribs are subsequently fitted to the wound body, that is to say the inner blade portion.

Optionally two centrifugal force supports 40 can be fixed or secured by adhesive to the inner blade portion 23, for each trailing edge segment portion 22a-22c.

The top side or the underside 29, 28 of the trailing edge segment portions 22a-22c can rest on the centrifugal force supports 40.

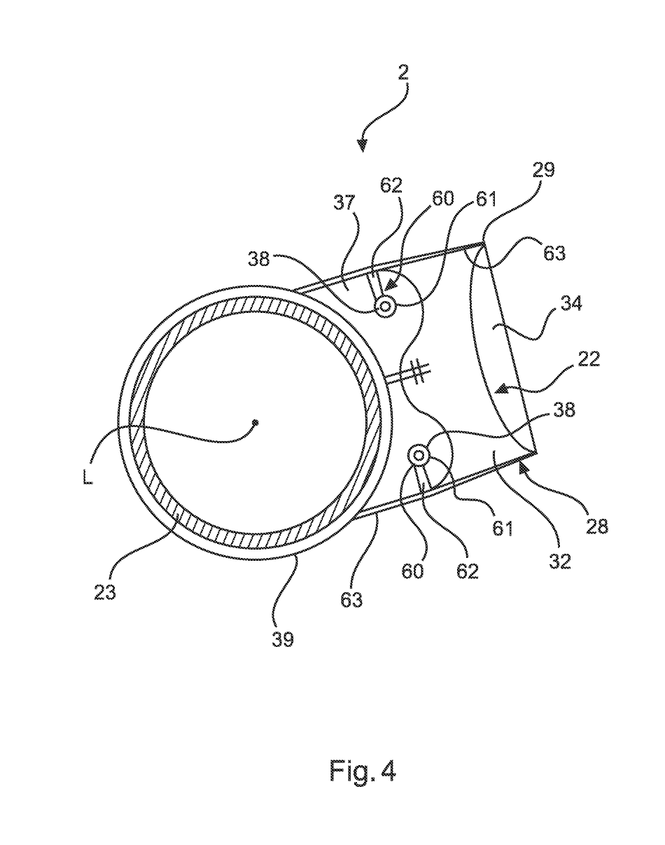

FIG. 4 shows a front view of a portion of a rotor blade 20 having a trailing edge segment portion 22 and an inner blade portion 23 in the direction of the longitudinal axis L of the rotor blade 20 according to a second embodiment of the invention. In this case the inner blade portion 23 is of an annular configuration. The trailing edge segment portion 22 has a top side 29 and an underside 28, to which a respective longitudinal edge of a reinforcing rib 32 is secured. The inner blade portion 23 has a U-shaped connecting rib 37 which connects the connecting rib 37 to the reinforcing rib 32 by way of two connecting systems 60. The connecting systems 60 each have a respective screw 61 and a transverse pin 62. The screw 61 is screwed to the transverse pin 62 and thus forms a connection between the trailing edge segment 22 and the inner blade portion 23.

In addition arranged around the annular inner blade portion 23 is an electrically conductive strip 39 connected to a lightning protection system of the wind turbine. In that case the electrically conductive strip 39 additionally serves as an attachment securing means in that it is braced with the connecting rib 37.

The connecting ribs 37 each have two holes 38, by way of which the trailing edge segment 22 can be connected to the inner blade portion 23 by a connecting element. In particular the connecting element can be in the form of a screw and/or transverse pin. In addition to the connecting element the connecting ribs 37 and the reinforcing ribs 32 can be glued together at their contact surfaces. That improves the holding force of the connection and the transmission of load to the trailing edge segment.

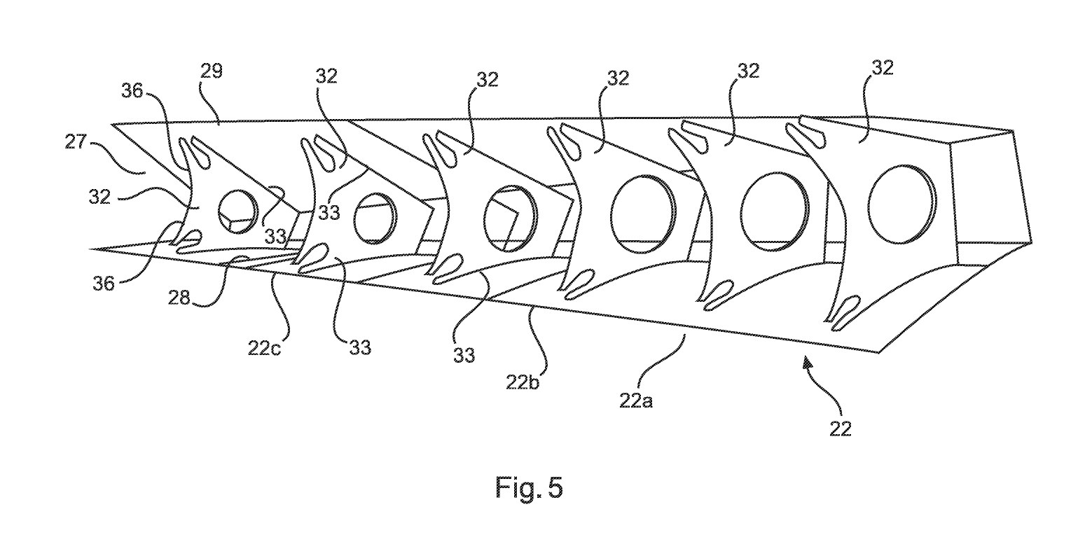

FIG. 5 shows an embodiment according to the invention of a portion of a trailing edge segment 22. The trailing edge segment portion 22 has a top side (suction side) 29 and an underside (pressure side) 28 which form a receiving space 27. Arranged in the receiving space 27 are six reinforcing ribs 32 which are intended to reinforce the trailing edge segment portion 22. In addition the configuration of the reinforcing ribs 32 is such that they permit a connection to a corresponding inner blade portion. An opening 34 is provided in each of the reinforcing ribs 32. The openings are provided in such a way that the reinforcing rib 32 can carry the loads from the inner blade portion, with at the same time minimization of the material consumption and minimization of the shearing stresses which can occur at the adhesive joints as a consequence of external loadings.

The reinforcing ribs 32 each have a transverse edge 36 adapted to the geometry of the inner blade portion. It will be seen from FIG. 5 that the transverse edge 36 is in the form of a semicircle. The corresponding inner blade portion is accordingly of a circular configuration. The longitudinal edges 33 of the reinforcing ribs 32 are adhesively secured to the top side 29 and the underside 28 respectively of the trailing edge segment portion 22.

Preferably two of the six reinforcing ribs 32 are used in relation to each trailing edge segment for bonding to the inner blade portion.

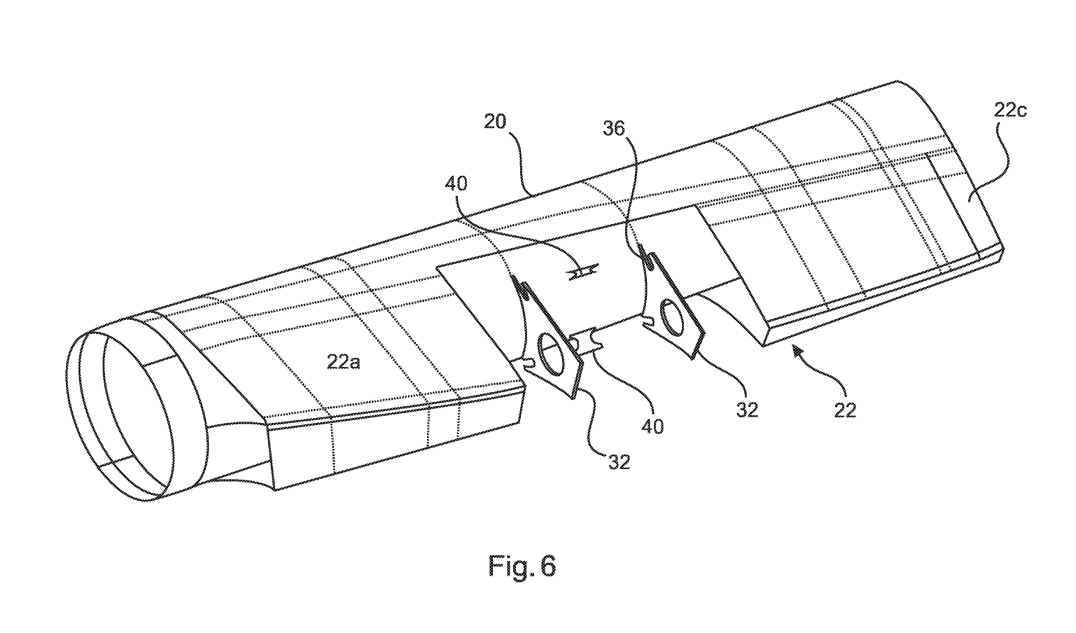

FIG. 6 shows a diagrammatic view of a portion of a rotor blade. The rotor blade has an inner blade portion 23 and a plurality of trailing edge segment portions 22a, 22c which together represent a trailing edge segment 22. The central trailing edge segment portion 22b is not shown in FIG. 6 so that the reinforcing ribs 32 and the centrifugal force supports 40 can be seen.

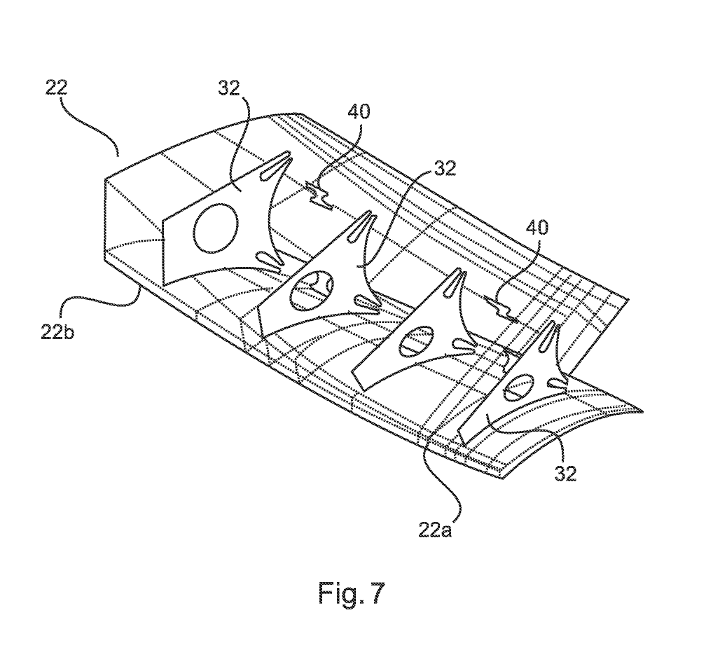

FIG. 7 shows a diagrammatic view of a trailing edge segment portion. FIG. 7 shows in particular the reinforcing ribs 32 and the centrifugal force supports 40 within the trailing edge segment portions 22a, 22b (concealed).

There is provided a wind turbine rotor blade having an inner blade portion 23 and a trailing edge segment 22 for increasing a profile depth of the rotor blade. The trailing edge segment can comprise a plurality of trailing edge segment portions 22a-22c. The trailing edge segment portions 22a-22c are respectively secured to the inner blade portion 23 in point form by way of first and second securing portions. The first securing portion can be provided by a reinforcing rib 32 which is disposed within the trailing edge segment portion 22a-22c, and a connecting rib 37 which is provided at the inner blade portion 23. The second securing portion can also be afforded by a reinforcing rib 32 in one of the trailing edge segment portions 22a-22c and a connecting rib 37 at the inner blade portion.

Almost complete load decoupling as between the inner blade portion and the trailing edge segment portions can be achieved by the only point-form connection (for example two connecting points for each trailing edge segment portion).

1. A wind turbine rotor blade, comprising:
a rotor blade root configured to couple the rotor blade to a rotor hub;
an inner blade portion extending from the rotor blade root in a direction of a longitudinal axis of the rotor blade;
a trailing edge segment having at least one trailing edge segment portion that increases a profile depth of the rotor blade in a region of the inner blade portion; and
at least first and second securing portions for securing the at least one trailing edge segment portion to the inner blade portion,
wherein the first securing portion is arranged at a predetermined spacing from the second securing portion in the direction of the longitudinal axis of the rotor blade, and
wherein the at least one trailing edge segment portion of the trailing edge segment is secured to the inner blade portion by the at least one first and second securing portions, wherein loads occurring at the inner blade portion are transmitted in point form by way of the first and second securing portions to the at least one trailing edge segment portion of the trailing edge segment.

2. The wind turbine rotor blade according to claim 1 wherein the at least one trailing edge segment portion has a top side and an underside, which together form a receiving space, wherein the first and the second securing portions are arranged in the receiving space.

3. The wind turbine rotor blade according claim 1 wherein the at least one trailing edge segment portion has, in the first and second securing portions, first and second reinforcing ribs for reinforcing the at least one trailing edge segment portion, wherein the first and second reinforcing ribs are adapted for connection to the inner blade portion, wherein first and second connecting ribs are arranged at the inner blade portion in the first and second securing portion, wherein the first and second connecting ribs are adapted for connection to the at least one trailing edge segment portion.

4. The wind turbine rotor blade according to claim 2 wherein the first and second reinforcing ribs each have a longitudinal edge that extends substantially over an entire profile depth of the at least trailing edge segment portion and are secured within the receiving space at the top side or the underside of the at least one trailing edge segment portion.

5. The wind turbine rotor blade according to claim 3 wherein the first and second reinforcing ribs have a transverse edge that corresponds to a shape of the inner blade portion.

6. The wind turbine rotor blade according to claim 3 wherein first and second connecting ribs are arranged at the inner blade portion in the first and second securing portion, wherein the first reinforcing rib and the first connecting rib are coupled together, wherein the second reinforcing rib and the second connecting rib are coupled together.

7. The wind turbine rotor blade according to claim 6 wherein the first reinforcing rib and the first connecting rib are coupled together by an adhesive, and wherein the second reinforcing rib and the second connecting rib are coupled together by an adhesive.

8. The wind turbine rotor blade according to claim 6 wherein the first reinforcing rib and the first connecting rib, and the second reinforcing rib and the second connecting rib, are coupled together by at least one of: a rivet connection, a screw connection, a bolt connection or a strap connection.

9. The wind turbine rotor blade according to claim 3 wherein the first reinforcing rib and the first connecting rib are arranged relative to each other in plane-parallel relationship, wherein the second reinforcing rib and the second connecting rib are arranged relative to each other in plane-parallel relationship.

10. The wind turbine rotor blade according to claim 3 wherein the first and second connecting ribs are of a U-shaped or double T-shaped configuration.

11. The wind turbine rotor blade according to claim 3 wherein the first and second connecting ribs include holes for connecting to the first and second reinforcing ribs.

12. The wind turbine rotor blade according to claim 1 wherein the inner blade portion is made from a fiber composite material and of an elliptical or circular cross-section.

13. The wind turbine rotor blade according to claim 3 wherein the first and second connecting ribs are wound into the inner blade portion.

14. A wind turbine, comprising
at least one wind turbine rotor blade according to claim 1.

15. A method of producing a wind turbine rotor blade, the method comprising:
connecting at least one trailing edge segment portion to an inner blade portion by at least first and second securing portions at a predetermined spacing relative to each other in a direction of a longitudinal axis of the wind turbine rotor blade,
wherein loads occurring at the inner blade portion are transmitted in point form by way of the first and second securing portions to the at least one trailing edge segment portion.

16. The wind turbine rotor blade according to claim 1 wherein the inner blade portion is in the form of a wound body.

17. The wind turbine rotor blade according to claim 4 wherein longitudinal edges of the first and second reinforcing ribs are secured within the receiving space at the top side or the underside of the trailing edge segment portion.
